(19) United States
(12) Patent Application Publication
(10) Pub. No.: US 2011/0187377 A1
(43) Pub. Date: Aug. 4, 2011

(54) Battery Charger Tester With Individual Cell Temperature Measurement

(76) Inventors: Dale Boysen, Plainwell, MI (US); Dennis Robinson, Portage, MI (US); Xia Weixing, Portage, MI (US); William Wittliff, Gobles, MI (US)

(21) Appl. No.: 13/019,441

(22) Filed: Feb. 2, 2011

Related U.S. Application Data
(60) Provisional application No. 61/301,097, filed on Feb. 3, 2010.

(51) Int. Cl. G01N 27/416

(52) U.S. Cl. 324/426

(57) ABSTRACT

A method and apparatus for sensing the temperature of each individual cell of a battery during the testing and charging. The method and apparatus can monitor the temperature of the cells of the battery, the charger or both. Additionally, a user can be notified when the temperature is at or exceeds a predetermined level. The temperature data is also used to aid in efficiently charging the battery and determining of the battery is defective.

### CROSS-REFERENCE TO RELATED APPLICATIONS

This application claims priority to provisional U.S. patent application entitled “Battery Charger Tester with Individual Cell Temperature Measurement,” filed Feb. 3, 2010, having Ser. No. 61/301,097, the disclosure of which is hereby incorporated by reference in its entirety.

### FIELD OF THE INVENTION

Embodiments of the present invention generally relate to a power source charger and tester. More particularly, the present invention relates to a battery charger and tester that measures a temperature of each cell of the battery during charging and testing.

### BACKGROUND OF THE INVENTION

Rechargeable batteries are an important source of clean portable power in a wide variety of electrical applications, including automobiles, boats and electric vehicles. Lead-acid batteries are one form of rechargeable batteries that are commonly used to start engines, propel electric vehicles, and to act as a source of back-up power when an external supply of electricity is interrupted. Because the lead-acid batteries can be depleted of power over time, such as when they are not in use over a period of time, or when a light in a car is left on for an extended period of time, they need to be recharged and tested. A number of battery testers and chargers have thus been developed to charge and test lead-acid battery.

During the charging period of the battery, the temperature of the battery is an indicator as to how successfully the battery is accepting the charge. However, measuring the overall temperature of a battery may not be an accurate indicator of the condition of the battery. There is a need for a battery charger and tester to include a temperature sensing device, which monitors each cell of the battery throughout the entire charging and testing process.

### SUMMARY OF THE INVENTION

The foregoing needs are met, to a great extent, by the present invention, wherein in one aspect an apparatus is provided that in some embodiments the apparatus is a battery charger/tester that includes the ability to measure the temperature of each battery cell during testing and charging.

The foregoing needs are met, to a great extent, by one or more embodiments of the present invention. In accordance with one such embodiment, a battery charger and tester is provided, which can include a controller that controls testing and charging functions of the battery charger and tester, a memory in communication with the controller and stores a battery test and a charging procedure, an input device to input information into the battery charger and tester, the input device in communication with the controller, and a plurality of sensors configured to coupled to a battery in order to sense a temperature of each individual cell of the battery during charging, the plurality of sensors communicating with the controller.

In accordance with another embodiment of the present invention, a battery charger and tester is provided, which can include a means for controlling testing and charging functions of the battery charger and tester, a means for storing a battery test and a charging procedure and is in communication with the means for controlling, a means for inputting information into the battery charger and tester, the means for inputting in communication with the means for controlling, and a plurality means for sensing configured to coupled to a battery in order to sense a temperature of each individual cell of the battery during charging, the plurality of means for sensing communicating with the means for controlling.

In accordance with yet another embodiment of the present invention, a method of sensing a temperature of a battery is provided, which can include the step of coupling a plurality of temperature sensors of a battery charger and tester to the battery to sense the temperature in each cell of the battery during a charging session, detecting the temperature of each cell of the battery with the plurality of temperature sensors while the battery is charging, sending the temperature of each cell of the battery to the battery charger and tester, and adjusting a rate in which the battery is charged based on the detected temperature of each cell.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a hardware block diagram of a battery charger and tester according to an embodiment of the current invention.

FIG. 2 is a system diagram of the battery charger and tester coupled to the battery with the temperature sensors.

### DETAILED DESCRIPTION OF THE PREFERRED EMBODIMENT

The present invention relates a battery charger and tester with a temperature sensing device for detecting the temperature of each cell of a battery being tested and charged, as well as, detecting the temperature of the battery and charger itself. The battery can be any type such as lead acid, lithium, sealed valve regulated lead acid, and any battery that have cells therein. In one example, a 12 volt vehicle battery can have a total of six cells that are being tested and charged. In an embodiment of the invention, each cell's temperature will be individually measured and monitored during testing and charging by the battery charger and tester.

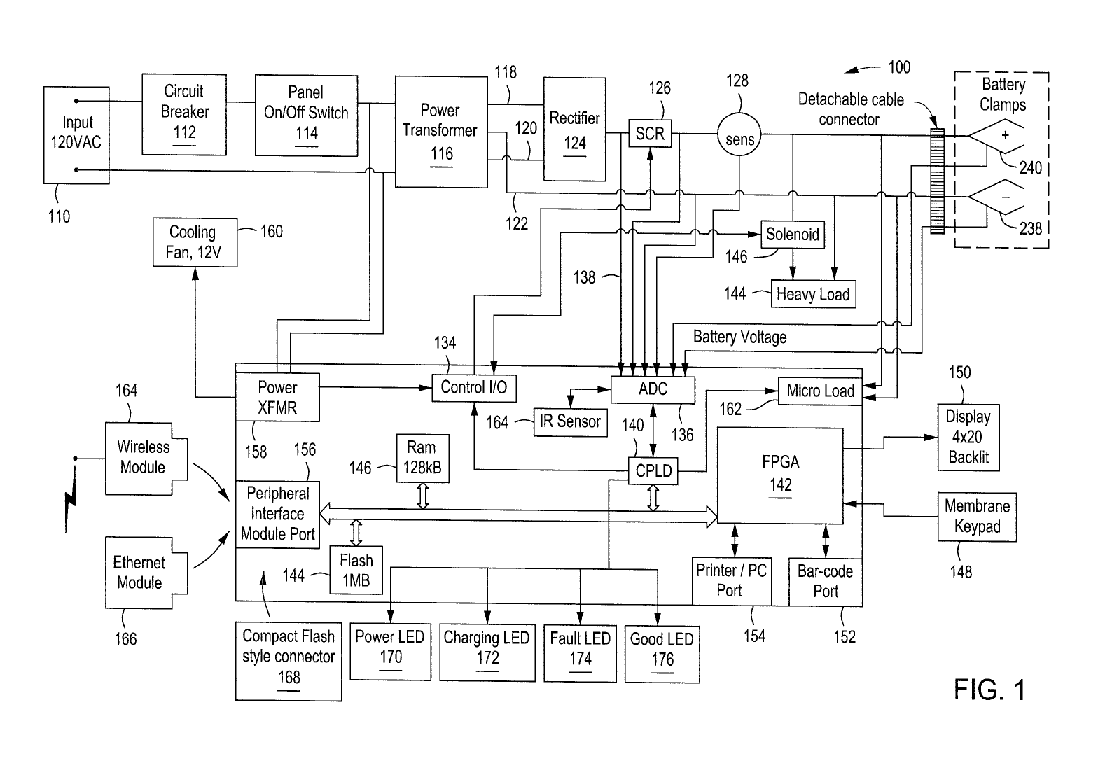

FIG. 1 is a hardware block diagram of a battery charger tester according to an embodiment of the current invention. The battery charger and tester 100 (“charger 100”) can include a power source 110 that provides a 120V (volts) AC (alternating current) to the charger 100. A circuit breaker 112 is provided to prevent damage that can be caused by a sudden power surge or a short. A power switch 114 is linked to the power source 110 to enable an operator to turn the charger 100 on or off.

A power transformer 116 is provided to step down both the voltage and current to a level that enables the charger 100 to charge and/or test the battery. In one embodiment, the power source 110 supplies the charger 100 with 120V AC. The power transformer 116 reduces the 120V AC to approximately 20-25V AC, which is optimal for charging the battery. Two lines 118, 120 from the power transformer 116 are inputted into a full-wave rectifier 124 and a third line 122 is directly coupled to a negative clamp 238. The lines 118, 120 pulse alternately through the rectifier 124 at a cycle of 60 Hz, for example. The diodes of the rectifier 124 convert the positive AC voltage to DC (direct current) power supply. The third line 122 provides a return path for the negative voltage of outputs 118, 120 to return to the power transformer 116.

A silicon control rectifier (SCR) 126 or thyristor is included in an embodiment of the invention to regulate the output from the rectifier 124 to the battery. Exiting from the rectifier 124 is a pulsed positive sine waveform with peak voltages and current. The sine waveform results in varying voltages and current being outputted from the rectifier 124. The SCR 126 essentially operates as a switch allowing certain voltages and/or current to pass to the battery.

The operator can choose either a voltage or a current or both to charge the battery. This selection is called a set-point. This set-point is then transmitted to a FPGA 142 (field programmable gate array, discussed below), which then determines at which point in the sine wave to allow voltage to pass through to the battery. This point in the sine wave is related to the set-point as chosen by the operator. In one embodiment, the set-point, depending on the selection of the operator, is situated on the sine wave by starting from the end of the sine wave and working in a rearward direction. Once the set-point is located on the sine wave, the voltage underneath the sine wave is allowed to pass through to the battery. Therefore, the set-point voltage can be a mean value of a range of voltages.

For example, if the operator decides to charge the battery at 12V, this set-point of 12V is entered into the charger 100 via a membrane keypad 148. The set-point is transmitted to the FPGA 142, which then determines at which point in the sine wave to allow the voltage or current to pass through to the battery. The 12V set-point in this example permits voltages larger than and less than 12V to pass through to the battery. The mean of the voltages distributed to the battery will approximately equal twelve volts.

The SCR 126 operates essentially as a switch and allows current or voltage to pass to the battery at a set-point fixed by the operator. The SCR 126 can operate based on either voltage or current or a combination thereof. The SCR 126 is normally switched off until it receives a signal from an I/O control (input/output) 134. The voltage or current exiting from the rectifier 124 is transmitted to an ADC (analog-to-digital converter) 136. The ADC 136 in turn transmits the voltage or current information to a linked CPLD (computer programmable logic device) 140, which is linked to the FPGA 142. The FPGA 142, simulating as a processor, determines the operability of the SCR 126 by comparing the previously programmed set-point value with the output value of the rectifier 124. If the output value of the rectifier 124 is equal or greater than the set-point of the SCR 126, then the FPGA 142 instructs the I/O control 134 to send a signal to the SCR 126 to allow the output voltage or current to pass to the battery. For example, if the operator desires a minimum current of 20 amps, the SCR 126 will allow a current equal to or exceeding 20 amps to pass to the battery. The amps can be verified by a current sensor 128.

Data can be inputted into the FPGA 142 through the input device 148, such as a keypad. The FPGA 142 can transmit to and receive information from an output display 150, a serial port 154, such as a printer port, a second serial port 152, such as an infrared bar code reader, a module port 156 that can accept various communication modules, or any other device that can communicate with the FPGA. The serial ports and the module port can be replaced with an RS-432, an infrared serial port or a wireless radio frequency port, such as BLUETOOTH™, or any other similar device.

The display 150 can be an integrated display or a remote display that displays information, such as data gathered from the charging and testing of the battery, and menu information. Additionally, the display 150 can notify the operator of any problems that have been detected. The display may also be a touch screen display for inputting information.

In some embodiments of the current invention, the serial port is a bar code port 152 and may serve to operably connect a bar code reader (not shown) to the FPGA 142 or a microprocessor (not shown). In some embodiments, the bar code port 152 may be a conventional component, such as an RS-232. The bar code reader may be, for example, a conventional optical bar code reader, such as a gun or a wand type reader.

The operator swipes or aims the bar code reader on a bar code that is associated with the particular battery to be charged or tested and reads the bar code. The bar code itself may be affixed to the battery at the time of manufacture, purchase, or service. The bar code may contain information, or point to information stored in a database. The database may be located within the FPGA 142, a storage media 168 or located remotely and accessed electronically. Examples of remotely located databases include data based accessible by the Internet, Ethernet, or other remote memory storage facility.

The bar code may provide a variety of information regarding the battery. For example, the bar code may provide information regarding the battery type (e.g. gel, flooded lead acid, deep cycle), the battery rating (cold cranking amps), maintenance information, serial number, lot number, warranty information, and a manufacture date code. This data can be used to select parameters for the test or charge cycle. The data provided by the bar code is not limited to the examples given.

In some embodiments, the printer port 154 may print bar code labels that may be attached or otherwise associated with the battery and provide updated information. The updated information may include, among other things, service dates, service procedures, and warranty information (e.g. time left on warranty, who was the original purchaser, what types of service are and are not warranted, etc.) The printed label may then be read by the bar code reader in subsequent tests or charge cycles.

The charger 100 can include one or more LED's indicating states of the charger 100 or the battery during charging or testing. For example, LED 170 indicates that power is applied to the unit, LED 172 indicates a charge is being applied to the battery, LED 174 indicates a fault in the battery, and LED 176 indicates a good battery is detected.

Still referring to FIG. 1, a smaller transformer 158 provides current and voltage to the I/O control 134 and a cooling fan 160. The smaller transformer 158 provides a step down of both the voltage and current to a level that enables the I/O control 134 and a cooling fan 160 to operate. The cooling fan 160 helps to control the operating temperature of the charger 100.

The peripheral module port 156 can be constructed and arranged to receive an information relay device, such as an Ethernet wired module 166 and/or an Ethernet wireless module 164. The Ethernet modules 164, 166 communicate at data rates of 10 Mbps (10Base-T Ethernet), 100 Mbps (Fast Ethernet), 1000 Mbps (Gigabit Ethernet), and other data rates. The Ethernet modules 164, 166 can relay information between the charger 100 and another device connected to the modules via a wire or wireless connection. The information relayed can include data from the result of the charging/testing of the battery, data of the battery's warranty information, data of the battery type (deep cycle, gel, etc.), data of battery make and model, data from previous charging/testing of the battery, firmware update, data from diagnostic or operating parameters of the charger 100, maintenance data of the charger 100, and any other data required by the operator.

The peripheral module port 156 is in communication with the FPGA 142. Information can be exchanged between the peripheral module port 156, the Ethernet modules 164, 166, and the FPGA 142. The Ethernet modules 164, 166 can relay the information to and from a remote device, such as a network server, a printer, a personal computer, a workstation, a file server, a print server, other communication devices, such as a fax machine, a cellular/digital phone, a pager, a personal digital assistant, an email receiver, and a display. Through the use of the Ethernet modules 164, 166 any information, such as the information of the battery tested by the charger 100, can be relayed to a printer server and printed. Thus, the charger 100 is not dependent on a stand-alone printer that may be down, and can print to any networked printer, thereby saving time and money to the operator.

With the Ethernet module 164, 166, information can also be stored remotely such as on a workstation, a file server or other data storage device. For example, after the charger 100 concludes the charging/testing of the battery, the information from the test/charge can be relayed and stored on a networked personal computer. With the information stored on the networked personal computer, the information from any previous charge/test can be compared with the latest information, a report can be generated and forwarded to the appropriate personnel.

If the chargers 100 (same or similar model) that are used by the operator are “networked” together, the chargers' firmware can be updated simultaneously. Conventionally, to update firmware, a laptop is hooked up to the charger 100 and the new firmware is uploaded. Once the upload is completed, the operator then must go to the next charger 100 and repeat the process until all of the chargers 100 are updated with the new firmware. By being able to upload new firmware onto networked chargers 100, the update process will be less time consuming, and thus cost-effective for the operator. By having the chargers 100 networked via the Ethernet modules 164, 166, information from all the chargers 100 can be relayed and displayed to the operator. Because the chargers 100 can be networked, the operator does not have check each individual charger 100 to see if the charging and testing is completed and save valuable time and money. Additionally, by being networked, the chargers 100 can be instructed to run diagnostics and other functions remotely without having to individually program each charger 100.

In another embodiment, a notification system is provided to notify the operator when there is a problem with the charger 100 or the battery or when the charging/testing is completed. Typically, the operator has to physically check the status of the charger 100 and often would have to return many times to see if the charging/testing is completed. With the charger 100 having Ethernet connection modules 164, 166, the status information can be relayed to a remote location, such as the network server or the personal computer, which can be programmed to notify the operator of any problems or the completion of the charging/testing. Because the operator can be notified of any problems, the operator can take appropriate measures, such as terminating the charging of the battery, because charger 100 or the battery is overheating. By being notified of any problems, the operator can save money due to a decrease in electricity usage and decrease the possibility of an explosion due to overcharging the battery. Notification of the operator can be done with a personal computer that can notify the operator via another display, by pager, by fax, by email, by phone, by computer or by any means that will relay the requested information to the operator.

In another embodiment of the invention, the peripheral module port 156 can be constructed and arranged to accept a removable data storage media 168 (“storage media”). Information can be exchanged between the peripheral module port 156, the storage media 168, and the FPGA 142. The storage media 168 can be permanently fixed to the charger 100 to provide additional memory or can be removable, as required by the operator. The storage media 168 can transfer information to and from the charger 100. The information can include data from the result of the charging/testing of the battery, the battery's warranty information, the battery type (deep cycle, gel, etc.), the battery's make and model, data from previous charging/testing of the battery, firmware update, data from diagnostic or operating parameters of the charger 100, maintenance data of the charger 100, and any other data required by the operator.

The storage media 168 can include, but not limited to floppy disc (including ZIP); tape drive cartridge (such as DAT); optical media (such as CD-ROM, DVD-ROM, etc.); flash memory (such as smart media, compact flash, PC card memory, memory sticks, flash SIMMs and DIMMS, etc.); magnetic based media, magneto optical; USB drives; or any other storage media that an operator can store or retrieve information from it. A person skilled in the art will recognize that any storage media can be used.

One use of the storage media 168 is to update firmware, wherein the storage media can be programmed with the firmware update and loaded into the charger 100. By using the user interface 148, the operator can select the “update firmware” option from a menu that was previously provided to the charger 100. The charger 100 is able to retrieve the new firmware and update the charger 100. In another example, the operator can use the storage media 168 to store information regarding the battery that was charged/tested. The information can be downloaded into the storage media 168, such as a compact flash card, and can be sent to the appropriate person. Additionally, the storage media 168 can contain information from the charging/testing result of a battery at another location and can be uploaded into the charger 100 and displayed to the operator. Alternatively, the information can be relayed via the Ethernet module to be viewed, stored, or printed at a remote location. The storage media 168 can also provide an image of a soft-core microprocessor to the FPGA 142 during start-up. Additional memory RAM 146 and flash memory 144 can be utilized by the FPGA.

The charger 100 can have more than one peripheral module port 156 so that a communication nodule, a storage media module, and as many other modules as needed can be onboard the charger. The peripheral module port 156 provides flexibility to the charger 100 and provides a port so that any new device can be added to the charger as needed by the operator.

As stated above, the current sensor 128 is provided at the output of the SCR 126 to monitor or sense the current exiting from the rectifier 124 and the SCR 126. The current from the rectifier 124 is relayed via line 138 to the ADC 136, which like the voltage is fed to the CPLD 140 and then onto the FPGA 142. The FPGA 142 verifies if the current from the rectifier 124 is equal to or exceeds the current set-point value. The output from the current sensor 128 is directed to the battery clamps 238, 240.

Referring still to FIG. 1, in an embodiment of the invention, a Sabre Battery Test procedure is used as a heavy load test to analyze the condition of the battery. The heavy load test is applied with a heavy load 144 that includes a solenoid switch 146. The solenoid switch 146 is operated by the FPGA 142 through the I/O control 134 via the CPLD 140. The solenoid switch 146 in the heavy load test ensures that a high load amperage test can be efficiently and safely transmitted to the battery. One of ordinary skill in the art will recognize that the solenoid 146 can be replaced with electronic switching devices, such as transistors, in an alternate embodiment. Further, a micro load 162 can also be used alone or in conjunction with the heavy load 144.

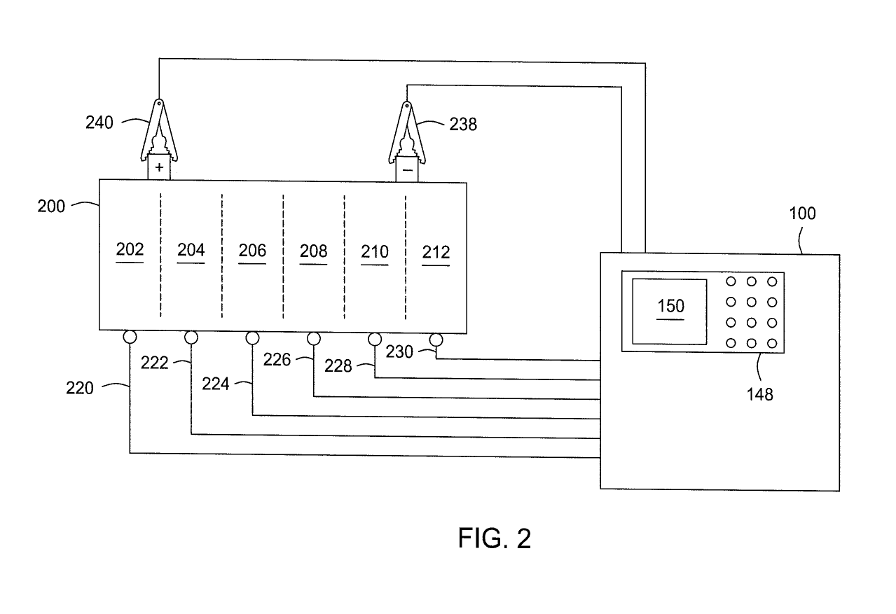

FIG. 2 illustrates the charger 100 connected to a battery 200 according to an embodiment of the invention. The charger 100 is connected to the battery 200 via the battery clamps 238, 240 in order to test and charge the battery 200. The battery in this embodiment includes six cells 202, 204, 206, 208, 210 and 212. In this embodiment, the battery's temperature during testing and charging is measured and monitored. Measuring a single point on the battery during testing and charging is not an as effective as one cell may overheat, but the overall battery temperature at the single point being measured may not rise to a level of concern until a much later point in time. Thus, the charger 200 can continue to charge the battery and the results of the charge may be off or the single cell that is overheating can emit dangerous gases as a result of boiling electrolyte in the single cell. The gas may be flammable and thus, creates a dangerous situation during charging or testing.

As shown, there are six temperature sensors 220, 222, 224, 226, 228 and 230 for each respective cell (202, 204, 206, 208, 210, 212) of the battery 200. The temperature sensors can be any types of sensors including thermocouple, thermistor, thermal resistive sensor, infrared (discussed below), bimetallic devices, thermometer, change-of-state sensors, silicon diode and others. The sensor can be placed directly in contact with the cells or indirectly contacting the cells so long as the temperature of each cell can be measured. There can be as many sensors as there are cells. The temperature sensors can transmit information via a wired or a wireless connection to the charger or another remote device.

In one embodiment, thermocouples are used and they may include an outer sheath, such as Teflon™, in order to work in acidic environments. The thermocouples can be positioned so that they contact directly or indirectly with the six cells of the battery. Each thermocouple may be placed under each cell to measure its temperature or in contact with a portion of the battery where the individual cell is located. By measuring each cell, the charger can make a determination on the status of the battery during testing or charging. For example, if a particular cell is overheating during charging in relation to other cells, the charger can determine that the battery is defective. Similarly if more than one cell is overheating in relation to the remaining cells, the charger can determine that the battery is defective.

Further, if the charger determines that a cell or cells are overheating, the charger can decrease the charging rate (decreasing voltage or current to the battery) of the battery until over heating is no longer an issue or stop charging all together. The charger can compensate so that over heating will not permanently damage the cell. The charger can automatically and dynamically make the adjustment to the charging as needed based on the temperature of the battery. Additionally, the collective measured temperature of the cells can be used by the controller to calculate the overall temperature of the battery for use in determine if the battery is defective or not charging properly.

As previously stated, one end of the thermocouple (measuring portion) can be placed near or under each cell of the battery while the other end is attached to the charger. Each end of the thermocouple can be directly attached to the charger or it can be attached to an intermediary receptor, which ultimately attach to the charger. Any suitable connections on the charger can be used such as the module port or the serial port. Further, the thermocouple may have a wireless transmitter to wirelessly transmit the information to the charger or a remote device.

In another embodiment, the temperature sensor can be an infrared temperature sensor 164, which aids in monitoring both the charger 100 and the battery being charged. The infrared temperature sensor 164 ensures that both the battery and charger 100 are maintained are safe levels. There can be six infrared temperature sensors 164 for each cell of the battery. For example, there can be six infrared temperature sensors 164 for a 12 volt battery.

The infrared sensor 164 can also be contained within a housing of the charger to measure the temperature of the charger during testing and charging. The housing is placed over the charging battery for safety reasons especially in the instance that, while charging, the battery unexpectedly explodes. The housing aids in containing the surrounding areas from the contaminants of the exploded battery.

In an embodiment, the infrared temperature sensor 164 is linked to the ADC 136, essentially an input to the ADC 136, which relays the information to the CPLD 140, which then relays it to the FPGA 142. The FPGA 142, with the help of the infrared temperature sensors 164, can monitor the temperature of the battery and relay the information, including any problems to the operator. The feedback from the infrared temperature sensor 164 for each cell and/or the charger can be used to alert the operator of the problem so that the operator can take the appropriate action.

In use, the charger 200 can be coupled to the battery for charging and testing through the battery clamps. The various types of battery testing can be conducted which may include a heavy load and/or a light load. Further, the charger can charge the battery for further use. Sensors can be placed near or in contact with the individual cells of the battery and relay the measurements to the charger. The charger can then monitor the temperature of each cells to ensure the cells are not overheating during testing or charging. Should the cell overheat during testing or charging, the charger can compensate by decreasing the voltage or current being placed on the battery or stop the current process all together.

The measurement of the individual cells as compared to a single point on a battery provides better accuracy, charging and testing of the battery. The operator can be alerted to a bad cell and the charging and testing can be terminated, thereby leading to safer environment and saving precious time and resources.

It should be noted that although a vehicle battery is described herein, any battery can be charged and tested according to the embodiments described herein. Further, the temperature sensor can also be used to increase the charging voltage or current as needed due to the temperature of the cell being lower than expected.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A battery charger and tester, comprising:
a controller that controls testing and charging functions of the battery charger and tester;
a memory in communication with the controller and stores a battery test and a charging procedure;
an input device to input information into the battery charger and tester, the input device in communication with the controller; and
a plurality of sensors configured to coupled to a battery in order to sense a temperature of each individual cell of the battery during charging, the plurality of sensors communicating with the controller.

2. The battery charger and tester of claim 1 further comprising:
a wireless communication port in communication with controller, the wireless communication port communicates a battery test result to a remote device.

3. The battery charger and tester of claim 1, wherein the controller automatically adjust the charging of the battery based on the sensed temperature of each individual cell.

4. The battery charger and tester of claim 1, wherein the controller determines if the battery is defective based on the sensed temperature.

5. The battery charger and tester of claim 1, wherein when the temperature detected by the sensors is at or above a predetermined temperature, an operator is notified.

6. The battery charger and tester of claim 1, wherein the controller dynamically adjust the charging of the battery based on the sensed temperature.

7. The battery charger and tester of claim 1, wherein the plurality of the sensors are coupled to the battery.

8. The battery charger and tester of claim 1, wherein the plurality of the sensors transmit the temperature wireless to the battery charger and tester.

9. A battery charger and tester, comprising:
a means for controlling testing and charging functions of the battery charger and tester;
a means for storing a battery test and a charging procedure and is in communication with the means for controlling;
a means for inputting information into the battery charger and tester, the means for inputting in communication with the means for controlling; and
a plurality means for sensing configured to coupled to a battery in order to sense a temperature of each individual cell of the battery during charging, the plurality of means for sensing communicating with the means for controlling.

10. The battery charger and tester of claim 9 further comprising:
a wireless communication port in communication with the means for controlling, the wireless communication port communicates a battery test result to a remote device.

11. The battery charger and tester of claim 9, wherein the means for controlling automatically adjust the charging of the battery based on the sensed temperature of each individual cell.

12. The battery charger and tester of claim 9, wherein the means for controlling determines if the battery is defective based on the sensed temperature.

13. The battery charger and tester of claim 9, wherein when the temperature detected by the means for sensing is at or above a predetermined temperature, an operator is notified.

14. The battery charger and tester of claim 9, wherein the means for controlling dynamically adjust the charging of the battery based on the sensed temperature.

15. The battery charger and tester of claim 9, wherein the plurality of the means for sensing are coupled directly to the battery.

16. The battery charger and tester of claim 9, wherein the plurality of the means for sensing transmit the temperature wirelessly to the battery charger and tester.

17. A method of sensing a temperature of a battery, comprising the steps of:
coupling a plurality of temperature sensors of a battery charger and tester to the battery to sense the temperature in each cell of the battery during a charging session;
detecting the temperature of each cell of the battery with the plurality of temperature sensors while the battery is charging;
sending the detected temperature of each cell of the battery to the battery charger and tester; and
adjusting a rate in which the battery is charged based on the detected temperature of each cell.

18. The method of claim 17, wherein the adjusting step is done automatically.

19. The method of claim 17, where in the adjusting is step is done dynamically.

20. The method of claim 17 further comprising of the step of:
determining if the battery is defective based on the determined temperature of each cell.
